(19) United States
(12) Patent Application Publication
(10) Pub. No.: US 2016/0289409 A1
(43) Pub. Date: Oct. 6, 2016

(54) SELF SEALABLE THERMOPLASTIC POLYURETHANE FOAMED ARTICLES AND METHOD FOR FORMING SAME

(71) Applicant: BASF SE, Ludwigshafen (DE)

(72) Inventors: Mark KUJAWSKI, St. Clair Shores, MI (US); Daniel A. ADAMS, Waterford, MI (US); Samer KAFFARANI, Dearborn Heights, MI (US); Mihai MANITIU, Macomb, MI (US); Brad MARTIN, Dearborn, MI (US); Guenter SCHOLZ, Brownstown Township, MI (US); Hung Manh PHAM, Monroe, MI (US)

(21) Appl. No.: 15/037,870

(22) PCT Filed: Nov. 19, 2014
(86) PCT No.: PCT/IB2014/002924

§ 371 Date: May 19, 2016

Related U.S. Application Data
(60) Provisional application No. 61/906,606, filed on Nov. 20, 2013.

(51) Int. Cl. C08J 9/00; C08G 18/42; E04C 2/20; E04B 1/88; E04D 12/00; E04F 15/20; C08G 18/48; C08G 18/08

(52) U.S. Cl. CPC C08J 9/00; C08G 18/48; C08G 18/42; C08G 18/14; C08J 9/0061; E04B 1/88; E04D 12/002; E04F 15/20; E04C 2/205; C08G 2101/0066

(57) ABSTRACT

A thermoplastic polyurethane foamed article has a density ranging from 0.3 to 0.8 g/cm3 measured at 25° C. and is self sealable in accordance with Section 7.9 of ASTM D1970/D1970M-11. The thermoplastic polyurethane foamed article is formed by melting and foaming a thermoplastic polyurethane composition having a durometer hardness ranging from 30A to 75D in the presence of a blowing agent.

### BACKGROUND OF THE INVENTION

1. Field of the Invention

The subject invention generally relates to thermoplastic polyurethane articles, and more specifically to thermoplastic polyurethane foamed articles that are self sealable.

2. Description of the Related Art

Underlayment articles (underlayments) are used in a wide variety of applications and can provide these applications with a barrier from moisture, sound and/or heat. In addition, such underlayment articles may provide other non-barrier functionality such as providing certain articles with support or cushioned support. These underlayment articles are typically introduced between a hidden support substrate and a visible outer surface.

For example, in commercial and residential roof construction, underlayments are typically introduced between a plywood substrate and the shingles, shakes or tiles and function to provide such roofing structures with a waterproof barrier and can function to minimize “picture framing” by creating a smooth surface over the plywood substrate. For flooring applications such as for tile floors, wood floors or carpeted floors, underlayments are typically introduced between the support substrate (such as plywood) and the overlying tiles, wood or carpeting to provide a cushioning and/or a waterproof barrier. In the commercial or residential building industry, underlayments may be introduced within wall structures between the support substrate and the visible outer surface (such as drywall or the like) to provide such applications with sound dampening, and/or weatherproofing. In automotive applications, underlayments may be used as heat shields between the engine and passenger compartments or as sound barriers within roofs, doors and trunks.

In many of these applications, the underlayment articles are secured using nails or staples. However, while these underlayment structures are waterproof, they typically do not form a watertight seal around the nails and staples and thus may serve as a point of water infiltration for these applications.

As such, there is a need to provide thermoplastic polyurethane foamed articles that are suitable for use as underlayments. Such underlayments may function as waterproof barriers and further form watertight seals around fasteners, such as nails and staples and other punctures.

### SUMMARY OF THE INVENTION AND ADVANTAGES

The subject invention provides a thermoplastic polyurethane foamed article having a density ranging from 0.3 to 0.8 g/cm³ measured at 25° C. and comprising a thermoplastic polyurethane composition having a durometer hardness ranging from a Shore A hardness of 30 to a Shore D hardness of 75 foamed in the presence of a blowing agent.

The thermoplastic polyurethane foamed article of the subject invention may be formed by melting a thermoplastic polyurethane composition having a durometer hardness ranging from a Shore A hardness of 30 to a Shore D hardness of 75 in the presence of a blowing agent and then foaming the melted thermoplastic polyurethane composition in the presence of the blowing agent.

Surprisingly and unexpectedly, the thermoplastic polyurethane foamed article is self sealable in accordance with Section 7.9 of ASTM D1970/D1970M-11; whereas unfoamed thermoplastic polyurethane articles having the same thermoplastic polyurethane composition and having the same dimensions (in terms of length and width) and similar weight per square foot did not achieve such self sealability.

### DETAILED DESCRIPTION OF THE INVENTION

The subject invention generally relates to thermoplastic polyurethane foamed articles, and more specifically to thermoplastic polyurethane foamed articles that are self sealable. The subject invention also provides a method for forming these thermoplastic polyurethane foamed articles and an underlayment for roofing and flooring which comprises the thermoplastic polyurethane foamed article.

As defined herein, the term “self sealable” refers to the ability of the thermoplastic polyurethane foamed article to seal around a roofing nail and prevent standing water from leaking through to the underside of the thermoplastic polyurethane foamed article in accordance with the procedure set forth in Section 7.9 of ASTM D1970/D1970M-11 (copyright Jun. 12, 2013), as modified herein. The modified procedure of the present invention utilizes the same testing procedure as described in Sections 7.9.2 and 7.9.3 of ASTM D1970/D1970M-11 (copyright Jun. 12, 2013) for evaluating a bituminous sheet material for self sealability and water retention, but replaces the properly dimensioned bituminous sheet material having a peel and stick backing layer (the material specified for evaluation via ASTM D1970/D1970M-11) with the afore-mentioned thermoplastic polyurethane foamed article having the same dimensions.

Specifically, the modified process for evaluating the test panel (i.e., the thermoplastic polyurethane foamed article in accordance with the present invention) derived from Section 7.9 of ASTM D1970/D1970M-11 (copyright Jun. 12, 2013) is as follows. First, a test panel having length and width dimensions of 300 by 300 mm is positioned onto a 10 mm thick piece of plywood of the same dimensions at room temperature.

Next, with two pieces of plywood placed underneath the thick piece of plywood for support, two 32 mm galvanized roofing nails are driven through the test panel at distances 25-51 mm apart near the center of the plywood so that the nail heads are flush with the top surface of the test panel. The pointed ends of the nails are tapped to raise the nail heads approximately 6 mm off the surface of the test panel.

Next, a bottom of a 4 liter can is removed with a can opener, and the can is centered, bottom side down, atop the test panel. A 6 mm bead of silicone sealant is applied around the outside rim of the can to bond it to the test panel. The sealant is allowed two hours to seal, and then another bead of sealant is applied around the inside of the can to form an assembly.

After waiting for 24 hours at ambient temperatures to allow the sealant to cure, the assembly is placed atop another 4 liter can which has the lid removed and the bottom intact. The upper can is filled to a depth of 127 mm with deionized or distilled water. The entire assembly is then placed into a refrigeration unit maintained at 4° C.+/−2° C. for a period of three days.

At the conclusion of the test, the top can and plywood are removed and any water remaining in the top can, on the shanks of the nails, or on the underside of the plywood is noted. The remaining water is removed from the top can and the inside of the can is blotted dry. The top can is then peeled away from the test panel and the test panel is peeled back to the nails. The underside is then inspected for any signs of water. The test panel is deemed to fail the test (i.e., is not self sealable in accordance with ASTM D1970/D1970M-11 as modified herein) if any water is found in the bottom can, on the nail shanks, on the underside of the plywood, or between the plywood and the test panel. The test panel is deemed to pass the test (i.e., is self sealable in accordance with ASTM D1970/D1970M-11 as modified herein) if the bottom can, the nail shanks, the underside of the plywood, and the area between the plywood and the test panel is dry.

The thermoplastic polyurethane foamed articles formed in accordance with the present invention meet this self sealability test (i.e., are self sealable in accordance with ASTM D1970/D1970M-11 as modified herein) and are formed by foaming a melted thermoplastic polyurethane composition in the presence of a blowing agent such as described further below. Conversely, unfoamed thermoplastic polyurethane articles having approximately the same weight per square foot (and measured at the same length and width dimensions according to Section 7.9 of ASTM D1970/D1970M-11) and formed from the same composition do not meet this self sealability test.

The term “thermoplastic polyurethane” (TPU), as used with respect to “thermoplastic polyurethane composition” and “thermoplastic polyurethane foamed article”, refers to a multi-phase block copolymer created when a polyaddition reaction occurs between an isocyanate and an isocyanate-reactive component. TPUs are generally known as being soft and processable when heated, hard when cooled, and capable of being reprocessed multiple times without losing structural integrity.

Typical thermoplastic polyurethane compositions are made from an isocyanate-reactive component and generally an equivalent amount of an isocyanate. Stated another way, the thermoplastic polyurethane compositions are the reaction product of the isocyanate-reactive component and the isocyanate.

The isocyanate-reactive component includes a polyol. The polyol is generally a polyether polyol or a polyester polyol or caprolactone or combinations thereof. TPUs formed from polyether polyols are generally be referred to as polyether TPUs. Similarly, TPUs formed from polyester polyols are generally be referred to as polyester TPUs, while TPUs formed from caprolactone are generally be referred to as polycaprolactone TPUs.

In addition to the polyol, the isocyanate-reactive component preferably also includes a chain extender such as a diol. Stated another way, the thermoplastic polyurethane compositions of the present invention are the reaction product of the polyol, the chain extender and the isocyanate.

The thermoplastic polyurethane composition formed from the reaction product of the polyol, the chain extender and the isocyanate includes linear polymeric chains in block-structures. Such chains contain low polarity segments which are rather long (called soft segments), alternating with shorter, high polarity segments (called hard segments). Both types of segments are linked together by covalent bonds, so that the segments actually form block-copolymers. The soft segments, formed via the reaction of the polyol and the isocyanate, provide flexibility to the TPU. The hard segments, formed via the reaction of the chain extender and the isocyanate, provide the TPU with toughness and other physical performance properties. The selection and relative proportions of the polyol, the chain extender, and the isocyanate impact the physical properties of the resultant thermoplastic polyurethane composition and any foamed article formed therefrom in terms of hardness, tensile strength, tear strength, compression set, abrasion resistance, and shrinkage and other properties such as chemical resistance.

It is to be appreciated that one or more isocyanates can be reacted with the isocyanate-reactive component to form the thermoplastic polyurethane composition. It is also to be appreciated that the isocyanate is not limited to any particular genus of isocyanate, e.g. the isocyanate can include monomeric isocyanate, polymeric isocyanate, and mixtures thereof. In addition, the isocyanate can include prepolymers, e.g. polyols reacted with excess isocyanate. Typically, the isocyanate comprises methylene diphenyldiisocyanate (MDI), such as 2,4′-MDI and 4,4′-MDI. Alternatively, the isocyanate may comprise toluene diisocyanate (TDI) (such as 2,4′-TDI or 2,6′-TDI), 1,5-naphthalene diisocyanate (NDI), p-phenylene diisocyanate (PPDI), 1,6-hexamethylene diisocyanate (HDI), cyclohexyl diisocyanate (CHDI), isophorone diisocyanate (IPDI),4,4-dicyclohexylmethane diisocyanate (HMDI), and any combination thereof.

Polyether polyols that are used to produce the thermoplastic polyurethane compositions of the present invention may be made, for example, by reacting an alkylene oxide, such as propylene oxide, with a strong base such as potassium hydroxide, optionally in the presence of water, glycols and the like. Other polyether polyols which can be utilized include, but are not limited to, those which are produced by polymerization of tetrahydrofuran or epoxides such as epichlorohydrin, ethylene oxide, propylene oxide, butylene oxide, styrene oxide, for example in the presence of Lewis catalysts such as boron trifluoride or other suitable initiator compounds, or by the addition of epoxides, optionally mixed or in succession, onto starter components with reactive hydrogen atoms such as water, alcohols, ammonia, or amines. Suitable initiator compounds contain a plurality of active hydrogen atoms, and include, but are not limited to, water, butanediol, ethylene glycol, propylene glycol (PG), diethylene glycol, triethylene glycol, dipropylene glycol, ethanolamine, diethanolamine, triethanolamine, toluene diamine, diethyl toluene diamine, phenyl diamine, diphenylmethane diamine, ethylene diamine, cyclohexane diamine, cyclohexane dimethanol, resorcinol, bisphenol A, glycerol, trimethylolpropane, 1,2,6-hexanetriol, pentaerythritol, and combinations thereof.

Other suitable polyether polyols include polyether diols and triols, such as polyoxypropylene diols and triols and poly(oxyethylene-oxypropylene)diols and triols obtained by the simultaneous or sequential addition of ethylene and propylene oxides to di- or trifunctional initiators. Copolymers having oxyethylene contents of from about 5 to about 90% by weight, based on the weight of the polyol component, of which the polyols may be block copolymers, random/block copolymers or random copolymers, can also be used. Yet other suitable polyether polyols include polytetramethylene glycols obtained by the polymerization of tetrahydrofuran.

The polyester polyols that may be used to form the thermoplastic polyurethane compositions may be formed, for example, from the condensation of one or more polyhydric alcohols with one or more polycarboxylic acids. Examples of suitable polyhydric alcohols include, but are not limited, to the following: ethylene glycol, propylene glycol such as 1,2-propylene glycol and 1,3-propylene glycol, glycerol; pentaerythritol; trimethylolpropane; 1,4,6-octanetriol; butanediol; pentanediol; hexanediol; dodecanediol; octanediol; chloropentanediol, glycerol monallyl ether; glycerol monoethyl ether, diethylene glycol; 2-ethylhexanediol-1,4; cyclohexanediol-1,4; 1,2,6-hexanetriol; 1,3,5-hexanetriol; 1,3-bis-(2-hydroxyethoxy) propane, 1,4- and 2,3-butylene glycol, neopentyl glycol, 1,4-bis-(hydroxymethyl)cyclohexane, trimethylolethane, together with di-, tri-, tetra-, and higher polyethylene glycols, di- and higher polypropylene glycols, together with di- and higher polybutylene glycols, and the like. Examples of polycarboxylic acids include the following: phthalic acid; isophthalic acid; terephthalic acid; tetrachlorophthalic acid; maleic acid; dodecylmaleic acid; octadecenylmaleic acid; fumaric acid; aconitic acid; trimellitic acid; tricarballylic acid; 3,3′-thiodipropionic acid; succinic acid; adipic acid; malonic acid, glutaric acid, pimelic acid, sebacic acid, cyclohexane-1,2-dicarboxylic acid; 1,4-cyclohexadiene-1,2-dicarboxylic acid; 3-methyl-3,5-cyclohexadiene-1,2-dicarboxylic acid and the corresponding acid anhydrides such as tetrahydrophthalic anhydride, hexahydrophthalic anhydride, tetrachlorophthalic anhydride, endomethylenetetrahydrophthalic anhydride, acid chlorides and acid esters such as phthalic anhydride, phthaloyl chloride and the dimethyl ester of phthalic acid, dimerized and trimerized unsaturated fatty acids, optionally mixed with monomeric unsaturated fatty acids, terephthalic acid monomethyl ester and terephthalic acid monoglycol ester.

The chain extender used to form the thermoplastic polyurethane composition according to the present invention suitably comprises compounds having 2 or more active hydrogens and molecular weights ranging from 60 g/mol to 400 g/mol, such as from 60 g/mol to 200 g/mol. Suitable chain extenders having 2 or more active hydrogens include, for example, polyols such as 1,4-butanediol, ethylene glycol, diethylene glycol, propylene glycol, 1,4-butylene glycol, 1,5-pentylene glycol, methylpentanediol, 1,6-hexylene glycol, neopentyl glycol, trimethylolpropane, hydroquinone ether alkoxylate, resorcinol ether alkoxylate, glycerol, pentaerythritol, diglycerol, dextrose, and a 1,4:3,6 dianhydrohexitol such as isomannide; isosorbide and isoidide; aliphatic polyhydric amines such as ethylenediamine, hexamethylenediamine, and isophorone diamine; and aromatic polyhydric amines such as methylene-bis(2-chloroaniline), methylenebis(dipropylaniline), diethyl-toluenediamine, trimethylene glycol di-p-aminobenzoate; alkanolamines such as diethanolamine, triethanolamine and diisopropanolamine.

In certain embodiments, the chain extender is a diol, such as the one or more diols from the list as provided above. If higher functional polyols, such as triols, are included in the reaction product, they are typically introduced in combination with the diols as provided above and in low relative amounts to limit crosslinking and prevent the resultant thermoplastic polyurethane composition from becoming too brittle.

The thermoplastic polyurethane compositions that are utilized in the present invention have a durometer hardness ranging from a Shore A hardness of 30 to a Shore D hardness of 75, such as from a Shore A hardness of 50 to a Shore D hardness of 60. The “Shore hardness” of the thermoplastic polyurethane composition refers to an empirical measurement used to test the composition's resistance to indentation or penetration under a defined force. Shore A measurements are typically performed upon more flexible types of thermoplastic polyurethane compositions, while Shore D measurements refer to more rigid grades. On both scales, the measurements range from zero to 100 with zero being very soft and 100 very hard. The measurements are performed using a durometer in accordance with the standards provided in ASTM D2240.

The relative amounts and chemical structures of each of the components comprising the isocyanate-reactive component, as well as the structure of the isocyanates, as noted above, may vary in relative amount so long as the thermoplastic polyurethane composition formed therefrom achieves a durometer hardness ranging from a Shore A hardness of 30 to a Shore D hardness of 75.

Suitable thermoplastic polyurethane compositions of the present invention having a durometer hardness ranging from a Shore A hardness of 30 to a Shore D hardness of 75 that may be used in the present invention include those commercially available from BASF Corporation of Florham Park, N.J. and sold under the trade name Elastollan®.

The blowing agent of the present invention may be a physical blowing agent, a chemical blowing agent, or a combination of a physical blowing agent and chemical blowing agent.

The terminology “physical blowing agent” refers to blowing agents that do not chemically react with the isocyanate and/or the isocyanate-reactive component of the thermoplastic polyurethane composition. The physical blowing agent can be a gas or liquid.

In certain embodiments, the physical blowing agent can also be a gas that is trapped within a thermoplastic shell, wherein the gas expands under heat which causes the shell to grow. The thermoplastic shell, in certain embodiments, may comprise a styrenic polymer.

In certain embodiments, the physical blowing agent may be introduced via a masterbatch containing both the physical blowing agent and a polymer matrix composition such as ethylene vinyl acetate (EVA) or a thermoplastic polyurethane composition that is the same or different from the thermoplastic polyurethane compositions as described above. In these embodiments, the physical blowing agent concentration in the masterbatch is between 25 and 75 parts by weight based upon the 100 parts by weight of the combination of the physical blowing agent and the polymer matrix composition.

The liquid physical blowing agent, in certain embodiments, evaporates into a gas when heated, and typically returns to a liquid when cooled. In certain embodiments, the liquid physical blowing agent is a liquefied gas such as liquefied carbon dioxide or liquid nitrogen. In certain embodiments, the liquefied gas is incorporated directly into the thermoplastic polyurethane composition after it is melted, as described further below.

The physical blowing agent is typically introduced to the thermoplastic polyurethane composition in an amount of from about 0.125 to about 15 parts by weight, such as from 4 to 6 parts by weight, based on 100 parts by weight of the combined weight of the polyol present in the isocyanate-reactive component and the blowing agent.

The terminology “chemical blowing agent” refers to blowing agents which chemically react to release a gas for foaming. In certain embodiments, the chemical blowing agent chemically reacts with the isocyanate and/or the isocyanate-reactive component of the thermoplastic polyurethane composition. One specific, non-limiting example of a chemical blowing agent is water, which reacts with the isocyanate to create carbon dioxide. Other non-limiting examples of chemical blowing agents include citric acid or hydrogen carbonate which can also create carbon dioxide.

The chemical blowing agent is typically introduced to the thermoplastic polyurethane composition in an amount such that, after reaction, the resultant blowing agent comprises from about 0.125 to about 15 parts by weight, such as from 4 to 6 parts by weight, based on 100 parts by weight of the combined weight of the polyol present in the isocyanate-reactive component and the blowing agent.

In certain embodiments, a melt strength enhancer may also be included with the thermoplastic polyurethane composition and blowing agent. Without intending to be bound by any theory, the melt strength enhancer is believed to increase the bubble strength of the thermoplastic polyurethane composition. Thus, when the thermoplastic polyurethane composition is foamed in accordance with the present invention, as described below, the resultant thermoplastic polyurethane foamed article has reduced bubble collapse, and hence increased bubble uniformity and bubble size, as compared with thermoplastic polyurethane foamed articles formed in the same manner from the same thermoplastic polyurethane composition but lacking the melt strength enhancer. It is also believed that melt strength enhancer does not positively or negatively influence the self sealability properties of the thermoplastic polyurethane foamed article.

If included, the melt strength enhancer is typically present in an amount up to 5%, such as from 0.1 to 5%, of the total weight of the thermoplastic polyurethane composition and the melt strength enhancer.

If included, the melt strength enhancer is preferably a polymer with epoxy functionality such as an epoxy-functional styrene acrylic copolymer. Exemplary epoxy-functional styrene acrylic copolymers that may be used in the present invention include those commercially available from BASF Corporation of Florham Park, N.J. and sold under the trade name Joncryl®. Alternatively, the melt strength enhancer, if included, may be a polyurethane composition, such as a thermoplastic polyurethane composition. In still further embodiments, two or more melt strength enhancers may be utilized.

Additional components may also be added to the thermoplastic polyurethane composition prior to foaming the thermoplastic polyurethane composition to form the thermoplastic polyurethane foamed article. Such additional components include, but are not limited to, waxes, lubricants, ultraviolet light stabilizers, antioxidants, compatibilizers, surfactants, friction modifiers, fillers, crosslinkers, plasticizers, flame retardants, colorants, or any combination thereof.

In addition, other polymers may be blended or otherwise incorporated or introduced with the thermoplastic polyurethane composition and melted to form the foamed thermoplastic foamed article as described above. Such polymers include, but are not limited to, polyethylene, polypropylene, polystyrene including high-impact polystyrene (HIPS), methyl-methacrylate-acrylonitrile-butadiene-styrene (MABS), acrylonitrile-butadiene-styrene (ABS), polyoxymethylene (POM), polybutylene terephthalate (PBT), ethylene vinyl acetate (EVA), or recycled tire rubber.

The present invention also discloses a method for forming a thermoplastic polyurethane foamed article from the thermoplastic polyurethane composition. Specifically, the thermoplastic polyurethane foamed article is formed by melting the thermoplastic polyurethane composition in the presence of the blowing agent (or blowing agent masterbatch) and any optional components and then foaming the melted thermoplastic polyurethane composition in the presence of the blowing agent. More specifically, the thermoplastic polyurethane composition is melted in the presence of the blowing agent and optionally the melt strength enhancer. The melting step is such that the blowing agent impregnates the melted thermoplastic polyurethane composition, causing bubbles to form therein. The melted thermoplastic polyurethane composition is then foamed in the presence of the blowing agent to form the thermoplastic polyurethane foamed article. The foaming of the melted thermoplastic polyurethane composition is the result of a pressure drop, or depressurization, of melted thermoplastic polyurethane composition, which causes the compressed gases within the thermoplastic polyurethane composition to expand and form the thermoplastic polyurethane foamed article.

Next, optionally, the thermoplastic polyurethane foamed article may be cured by heating the article for a period of time sufficient to cure the thermoplastic polyurethane foamed article. Alternatively, the thermoplastic polyurethane foamed article is allowed to remain at ambient temperatures for a period of time sufficient to achieve ambient cure of the thermoplastic polyurethane foamed article.

In one preferred method for forming the thermoplastic polyurethane foamed article of the present invention, the thermoplastic polyurethane composition and blowing agent and optionally the melt strength enhancer and other optional ingredients, as described above, are introduced into a processing device, such as an extruder, and preferably a single screw extruder. The processing device is heated to a temperature sufficient to melt the thermoplastic polyurethane composition, and, in the case of an extruder, the melted material is compressed and mixed. Further, in the case of an extruder, the melting may occur in stages in multiple heating zones. Gas formed from the evaporation of the liquid physical blowing agent during the heating process, or from the chemical reaction of the chemical blowing agent in the heating process, or otherwise generated or present from the blowing agent is impregnated within the melted thermoplastic polyurethane composition to form bubbles as a result of the pressure increase associated with the heating step.

Next, the thermoplastic polyurethane foamed article is formed by releasing the melted thermoplastic polyurethane composition from the processing device. The pressure drop, or depressurization, associated with releasing the melted thermoplastic polyurethane composition from the processing device (having a higher pressure) causes the compressed gas to expand, and hence the bubbled thermoplastic polyurethane composition to expand, and form the thermoplastic polyurethane foamed article.

In certain embodiments, wherein an extruder is used to melt the thermoplastic polyurethane composition, the thermoplastic polyurethane foamed article is produced by releasing the melted thermoplastic polyurethane composition impregnated with the gas from the blowing agent through a die opening in the extruder and onto a rolling conveyor belt. The size of the die opening and speed of the conveyor, as well as the force applied to push the melted thermoplastic polyurethane composition through the die opening (as controlled by the die geometry and draw down ratio), can be controlled to determine the thickness of the thermoplastic polyurethane foamed article formed. This is known to those of ordinary skill in the foaming art as a continuous process for forming the thermoplastic polyurethane foamed article.

Alternatively, wherein an extruder is used to melt the thermoplastic polyurethane composition in conjunction with an injection molding apparatus, the thermoplastic polyurethane foamed article is produced by releasing the melted thermoplastic polyurethane composition impregnated with the gas from the blowing agent into the injection molding apparatus having an internal cavity of a predetermined size. The pressure drop within the mold cavity causes the thermoplastic polyurethane composition impregnated with gas to expand to fill the mold cavity. After a period of time, the injection molding apparatus is opened, releasing the thermoplastic polyurethane foamed article.

Next, optionally, the thermoplastic polyurethane foamed article may be cured by introducing the article to a heating device, such as an oven, and heating the article for a period of time sufficient to cure the thermoplastic polyurethane foamed article. Alternatively, the thermoplastic polyurethane foamed article is allowed to remain at ambient temperatures for a period of time sufficient to achieve ambient cure of the thermoplastic polyurethane foamed article.

The resultant thermoplastic polyurethane foamed article, produced in accordance with the methods as described above, has a density ranging from 0.3 to 0.8 g/cm³ (measured at 25° C.), such as from 0.35 to 0.65 g/cm³. In addition, the thermoplastic polyurethane foamed article is self sealable in accordance with Section 7.9 of ASTM D1970/D1970M-11 as modified herein and described above, a fact which was both surprising and unexpected, given that unfoamed thermoplastic polyurethane articles formed from the same thermoplastic polyurethane composition under the same processing conditions and having the same weight per square foot did not achieve such self sealability when tested in accordance with Section 7.9 of ASTM D1970/D1970M-11.

In addition to being self sealable, the thermoplastic polyurethane foamed article of the present invention is lightweight, tear resistant, flexible, and non-adhesive to other layers and finds application in a wide variety of applications.

For example, thermoplastic polyurethane foamed articles formed in accordance with the present invention, at a thickness ranging from 0.6 to 2.0 mm and a weight ranging from 0.037 to 0.328 pounds per square foot, such as from 1.1 to 1.6 mm and a weight range of 0.068 to 0.262 pounds per square foot, are ideally suited for use as a single underlayment for roofing applications. In such applications, the underlayment is unrolled or otherwise introduced onto a plywood substrate material. Shingles, shakes, tiles or are then secured to the substrate material through the underlayment with nails and/or staples. The underlayment then seals itself around the nails and/or staples, creating a watertight seal in accordance with the procedure set forth in Section 7.9 of ASTM D1970/D1970M-11 as described above.

In related embodiments, the thermoplastic polyurethane foamed article, used as an underlayment in roofing applications, is part of a multilayer system and includes a scrim or other support structure, including but not limited to woven or nonwoven polyethylene, polyester, felt, and/or fiberglass.

In addition, thermoplastic polyurethane foamed articles formed in accordance with the present invention, at a thickness ranging from 0.6 to 2.0 mm and a weight ranging from 0.037 to 0.328 pounds per square foot, such as from 1.1 to 1.6 mm and a weight range of 0.068 to 0.262 pounds per square foot, are also suited for use as a single underlayment for flooring applications.

The underlayment formed from the thermoplastic polyurethane foamed article and used in roofing and flooring applications offers numerous advantages over conventional roofing and flooring underlayments.

The primary advantage of the present invention, as noted above, is that thermoplastic polyurethane foamed article creates a water-tight seal around penetrating nails and/or staples in accordance with the procedure set forth in Section 7.9 of ASTM D1970/D1970M-11.

Another advantage is that the thermoplastic polyurethane foamed article as used in roofing and flooring applications has a surface texture produced by the foaming process. The rough surface texture enhances walkability and safety during installation. The excellent abrasion resistance inherent to the thermoplastic polyurethane foamed article helps maintain the surface texture when walked on.

Another advantage is the low weight of the thermoplastic polyurethane foamed article as used in roofing and flooring applications. Having an underlayment of lower weight allows longer continuous rolls to be produced, reducing the number of seams required during installation. Lower weight roofing underlayments, for example, reduce the load on the worker when carrying the underlayment up ladders to the rooftop during installation.

Further, in commercial and residential roof construction, underlayments formed from the thermoplastic polyurethane foamed article of the present invention provide such roofing structures with a waterproof barrier that minimizes “picture framing” by creating a smooth surface over the plywood substrate.

Another advantage is that, unlike conventional roofing underlayments, the thermoplastic polyurethane foamed article does not require an adhesive backing to achieve nail sealability. This reduces waste, simplifies processing, and speeds installation. The thermoplastic polyurethane foamed article is also more easily removed when reroofing.

Yet another advantage is that the air trapped within the thermoplastic polyurethane foamed article acts as an insulator and helps regulate the temperature of the house or building.

Still a further advantage is that the roughened surface, foamed structure and viscoelastic properties of the thermoplastic polyurethane foamed article provide sound and vibration damping. This sound and vibration damping, for example, can be used to reduce noise in homes or businesses when installed below conventional flooring, such as hardwood floors, or can reduce vibrations when installed as a liner in the trunk of a vehicle such as an automobile.

Still another advantage is the ultraviolet light stability of the thermoplastic polyurethane foamed article, which allows the roofing underlayment to be installed and left in place for extended periods of time while maintaining mechanical properties suitable enough to remain waterproof and water-tight around nails and/or staples. This allows roofs to be quickly waterproofed without having to immediately apply shingles.

Still further, another advantage of the thermoplastic polyurethane foamed article is the moisture vapor transmission property inherent this material. The thermoplastic polyurethane foamed article of the present invention is permeable, or breathable, to air and water vapor. The moist air inside of a building, for example, is thus able to pass through the thermoplastic polyurethane foamed article after application. This therefore helps to prevent water damage, mold formation, and wood rot in the roofing or flooring structure.

Also, another advantage of the thermoplastic polyurethane foamed article is that it does not swell when exposed to water. Hence, the thermoplastic polyurethane foamed article will not wrinkle during or after application like conventional felt-containing roofing underlayments.

In addition, a processing advantage for forming the thermoplastic polyurethane foamed article in accordance with the present invention is that the processing can be done in a single step using conventional foam forming equipment. Blowing agents and color master batches and other optional ingredients are added prior to the foaming process.

The following examples are intended to illustrate the instant disclosure and are not to be viewed in any way as limiting the scope of the instant disclosure.

### EXAMPLES

The test samples below were tested for density at 25° C. and 50% relative humidity in accordance with ASTM D3574.

Self Sealability Testing Procedure—Modified in Accordance with Section 7.9 of ASTM D1970/D1970M-11

Thermoplastic polyurethane foamed article test panels, formed in accordance with the present invention as described below, were evaluated versus non-foamed thermoplastic polyurethane article test panels having the same length and width and approximately the same weight per square foot and formed from the same or similar thermoplastic polyurethane starting compositions. The test panels were evaluated according to self sealability in accordance with the procedure set forth in Section 7.9 of ASTM D1970/D1970M-11 (copyright Jun. 12, 2013), as modified herein and described below. The test was repeated two times for each test panel.

Specifically, the modified process for evaluating the test panels derived from Section 7.9 of ASTM D1970/D1970M-11 was as follows.

First, a test panel (described below) having dimensions of 300 by 300 mm was positioned onto a 10 mm thick piece of plywood of the same dimensions at room temperature.

Next, with two pieces of plywood placed underneath the thick piece of plywood for support, two 32 mm galvanized roofing nails were driven through the test panel at distances 25-51 mm apart near the center of the plywood so that the nail heads were flush with the top surface of the test panel. The pointed ends of the nails were tapped to raise the nail heads approximately 6 mm off the surface of the test panel.

Next, a bottom of a 4 liter can was removed with a can opener, and the can was centered, bottom side down, beneath a membrane. A 6 mm bead of silicone sealant was applied around the outside rim of the can to bond it to the test panel. The sealant was allowed two hours to seal, and then another bead of sealant was applied around the inside of the can.

After waiting for 24 hours at ambient temperatures to allow the sealant to cure, the assembly was placed atop another 4 liter can which had the lid removed and the bottom intact. The upper can was filled to a depth of 127 mm with deionized or distilled water. The entire assembly was then placed into a refrigeration unit maintained at 4° C.+/−2° C. for a period of three days.

At the conclusion of the test, the top can and plywood were removed and any water remaining in the top can, on the shanks of the nails, or on the underside of the plywood was noted. The remaining water was removed from the top can and the inside of the can was blotted dry. The top can was then peeled away from the test panel and the test panel was peeled back to the nails. The underside was then inspected for any signs of water. The test sheet was deemed to fail the test if any water is found in the bottom can, on the nail shanks, on the underside of the plywood, or between the plywood and the test panel. The test sheet was deemed to pass if the bottom can, the nail shanks, the underside of the plywood, and the area between the plywood and the test panel are dry.

### Test Panels

Test panels, both foamed and unfoamed, evaluated for self sealability as described in the Tables below, were prepared as extruded sheets or as injection molded plaques as described below. For these tests, a variety of thermoplastic polyurethane compositions commercially available from BASF Corporation of Florham Park, N.J. under the trade name Elastollan®, at a variety of Shore hardness values as described below, were utilized. In addition, thermoplastic polyurethane compositions were evaluated with and without melt strength enhancers. The results were summarized in Tables 1 and 2 below.

The TPU foamed articles described below as being “extruded” were processed by first introducing the thermoplastic polyurethane composition and any additional components (blowing agent, flow additive, and melt strength enhancer) into a single screw extruder, available from Coperion, having a six inch die opening tuned to provide a desired sheet thickness exiting the die opening as indicated in the Tables below. The extruder was tuned with the following temperature profile:
Zone 1 Temperature: 380° F. (193° C.)
Zone 2 Temperature: 390° F. (199° C.)
Zone 3 Temperature: 400° F. (204° C.)
Gate Temperature: 400° F. (204° C.)
Adaptor Temperature: 400° F. (204° C.)
Die Opening Temperature: 400° F. (204° C.)

The TPU foamed articles described below as being “injection molded” were formed according by first introducing the thermoplastic polyurethane composition and any additional components (blowing agent, flow additive, and epoxy-functional styrene acrylic copolymer) to a single screw extruder, available from Coperion, having a six inch die opening. The die opening was coupled to an injection mold. The extruded material exiting the extruder was injected into the injection mold and held in the injection mold for about 30 seconds at 70° F. (21° C.), wherein the test panel was ejected from the mold.

The extruder and injection mold combination were tuned with the following temperature profile:
Zone 1 Temperature: 380° F. (193° C.)
Zone 2 Temperature: 390° F. (199° C.)
Zone 3 Temperature: 400° F. (204° C.)
Gate Temperature: 400° F. (204° C.)
Adaptor Temperature: 400° F. (204° C.)
Die Opening Temperature: 400° F. (204° C.)
Spru Temperature: 340 F (171° C.)
Mold Temperature: 70 F (21° C.)

The test panels formed via the extrusion process or via the injection molding process as described were further processed in the following manner for evaluation. First, the extruded panels or injection molded panels were either “cured” or “uncured.” The “cured” test panels were processed further by placing the test panels in an oven at 100° C. for 16 hours prior to evaluation. The “uncured” test panels were left at ambient temperature for a period of 1 to 7 days prior to evaluation.

Finally, the uncured or cured test panels were cut into a 300 by 300 mm sheets and evaluated for self sealability in accordance with the procedure set forth in Section 7.9 of ASTM D1970/D1970M-11 (copyright Jun. 12, 2013) as described above. The test results of such testing are summarized in Table 1 and in Table 2 below:

TABLE 1
Unfoamed TPU Samples

| Type of | | | | | | | |
|---|---|---|---|---|---|---|---|
| TPU | | | | | | | |
| (Polyether | | | Adhered to | Density | Extruded/ | Sample | |
| or | Shore | | Substrate/Free | (g/cm³) - | Injection | Thickness | Weight |
| Polyester) | Hardness | Elastollan ®¹ | Film | at 25° C. | Molded | (mm) | (lb/ft²) |
| Polyether | 74 D | 1174D10 | Free Film | 1.2 | Extrusion | 0.4 | 0.098 |
| Polyether | 64 D | 1264D13 | Free Film | 1.18 | Injection | 1.6 | 0.387 |
| Polyester | 95 A | C95A15 | Free Film | 1.23 | Extrusion | 0.74 | 0.186 |
| Polyester | 95 A | B95A15 | Free Film | 1.22 | Extrusion | 0.5 | 0.125 |
| Polyether | 90 A | 1090A15 | Free Film | 1.154 | Extrusion | 0.4 | 0.095 |
| Polyester | 90 A | 1190A10 | Free Film | 1.13 | Extrusion | 0.56 | 0.13 |
| Polyether | 87 A | WY1144 | Adhered to | 1.2 | Extrusion | 1.6 | 0.197 |
| | | | Substrate | | | | |
| Polyether | 87 A | WY1144 | Free Film | 1.2 | Extrusion | 0.4 | 0.098 |
| Polyether | 85 A | 1185A15U | Free Film | 1.2 | Extrusion | 0.4 | 0.098 |
| Polyether | 85 A | 1085A15 | Free Film | 1.15 | Extrusion | 0.4 | 0.094 |
| Polyether | 85 A | 1185A10U | Free Film | 1.12 | Extrusion | 0.4 | 0.092 |
| Polyether | 85 A | 1185A10X | Free Film | 1.12 | Extrusion | 0.5 | 0.115 |
| Polyester | 85 A | 785A10 | Free Film | 1.18 | Extrusion | 0.84 | 0.203 |
| Polyether | 70 A | 1170A15U | Free Film | 1.1 | Extrusion | 0.4 | 0.09 |
| Polyether | 70 A | 1170A10U | Free Film | 1.08 | Extrusion | 0.4 | 0.088 |

¹Elastollan ® refers to thermoplastic polyurethane compositions commercially available from BASF Corporation of Florham Park, New Jersey.

TABLE 2
Foamed TPU Samples

| | Shore | | | | | | |
|---|---|---|---|---|---|---|---|
| | Hardness | | | | | | |
| | (of | | | | | | |
| | TPU | | | | | | |
| | base | Elastollan ®¹ and | Adhered | | | | |
| | resin, | formulation (% based | to | | | | |
| | not of | on combined weight | Substrate/ | Density | Extruded/ | Sample | |
| Type of | the | of all ingredients in | Free | (g/cm³) - | Injection | Thickness | Weight |
| TPU | foam) | formulation) | Film | 25° C. | Molded | (mm) | (lb/ft²) |
| Polyether | 64D | 87% 1164D + 3% | Free | 0.49 | Extruded | 1.09 | 0.098 |
| | | Joncryl ADR 4370² + | Film | | | | |
| | | 5% Konz 2894³ + 5% | | | | | |
| | | Konz 2883⁴. | | | | | |
| | | Uncured | | | | | |
| Polyether | 74D | 87% 1174D + 3% | Free | 1.26 | Injection | 1.5 | 0.387 |
| | | Joncryl ADR 4370 + | Film | | Molded | | |
| | | 5% Konz 2894 + 5% | | | | | |
| | | Konz 2883. | | | | | |
| | | Uncured. Uncured | | | | | |
| Polyether | 54D | 93% 1154D + 5% | Free | 0.32 | Extruded | 1.34 | 0.088 |
| | | Konz 2894 + 2% | Film | | | | |
| | | Konz 2884. Uncured | | | | | |
| Polyether | 54D | 93% 1154D + 2.5% | Free | 0.50 | Extruded | 1.25 | 0.128 |
| | | Konz 2894 + 2.5% | Film | | | | |
| | | Konz 2893 + 2% | | | | | |
| | | Konz 2884. Uncured | | | | | |
| Polyether | 74D | 93% 1174D + 5% | Free | 0.38 | Extruded | 1.22 | 0.125 |
| | | Konz 2894 + 2% | Film | | | | |
| | | Konz 2884. Uncured | | | | | |
| Polyether | 85A | 91.5% 1185A + 1.5% | Free | 0.37 | Extruded | 1.25 | 0.095 |
| | | Joncryl ADR 4370 + | Film | | | | |
| | | 5% Konz 2894 + 2% | | | | | |
| | | Konz 2884. Uncured | | | | | |
| Polyether | 74D | 91.5% 1174D + 1.5% | Free | 0.36 | Extruded | 1.28 | 0.94 |
| | | Joncryl ADR 4370 + | Film | | | | |
| | | 5% Konz 2894 + 2% | | | | | |
| | | Konz 2884. Uncured | | | | | |
| Polyether | 85A | 94.5% 1185A10 + | Free | 0.38 | Extruded | 1.13 | 0.088 |
| | | 3% Konz 2894 + | Film | | | | |
| | | 1.5% Joncryl ADR | | | | | |
| | | 4370 + 1% Konz | | | | | |
| | | 2883. Uncured | | | | | |
| Polyether | 85A | 92.5% 1185A10 + | Free | 0.4 | Extruded | 1.57 | 0.129 |
| | | 5% Konz 2894 + | Film | | | | |
| | | 1.5% Joncryl ADR | | | | | |
| | | 4370 + 1% Konz | | | | | |
| | | 2883. Cured | | | | | |
| Polyether | 85A | 92.5% 1185A10 + | Free | 0.37 | Extruded | 1.32 | 0.1 |
| | | 5% Konz 2894 + | Film | | | | |
| | | 1.5% Joncryl ADR | | | | | |
| | | 4370 + 1% Konz | | | | | |
| | | 2883. Cured | | | | | |
| Polyether | 85A | 94.5% 1185A10 + | Free | 0.68 | Extruded | 1.58 | 0.22 |
| | | 3% Konz 2894 + | Film | | | | |
| | | 1.5% Joncryl ADR | | | | | |
| | | 4370 + 1% Konz | | | | | |
| | | 2883. Cured | | | | | |
| Polyether | 85A | 92.5% 1185A10 + | Free | | Extruded | 1.7 | |
| | | 5% Konz 2894 + | Film | | | | |
| | | 1.5% Joncryl ADR | | | | | |
| | | 4370 + 1% Konz | | | | | |
| | | 2883. Cured | | | | | |
| Polyether | 85A | 92.5% 1185A10 + | Free | | Extruded | 1.94 | |
| | | 5% Konz 2894 + | Film | | | | |
| | | 1.5% Joncryl ADR | | | | | |
| | | 4370 + 1% Konz | | | | | |
| | | 2883. Cured | | | | | |
| Polyether | 85A | 92.5% 1185A10 + | Free | 0.6 | Extruded | 1.92 | |
| | | 5% Konz 2894 + | Film | | | | |
| | | 1.5% Joncryl ADR | | | | | |
| | | 4370 + 1% Konz | | | | | |
| | | 2883. Cured | | | | | |
| Polyether | 85A | 92.5% 1185A10 + | Free | 0.38 | Extruded | 1.26 | 0.098 |
| | | 5% Konz 2894 + | Film | | | | |
| | | 1.5% Joncryl ADR | | | | | |
| | | 4370 + 1% Konz | | | | | |
| | | 2883. Cured | | | | | |
| Polyether | 85A | 92.5% 1185A10 + | Free | | Extruded | 1.48 | |
| | | 5% Konz 2894 + | Film | | | | |
| | | 1.5% Joncryl ADR | | | | | |
| | | 4370 + 1% Konz | | | | | |
| | | 2883. Cured | | | | | |
| Polyether | 85A | 92.5% 1185A10 + | Free | 0.46 | Extruded | 1.5 | 0.141 |
| | | 5% Konz 2894 + | Film | | | | |
| | | 1.5% Joncryl ADR | | | | | |
| | | 4370 + 1% Konz | | | | | |
| | | 2883. Cured | | | | | |
| Polyether | 85A | 92.5% 1185A10 + | Free | | Extruded | 1.92 | |
| | | 5% Konz 2894 + | Film | | | | |
| | | 1.5% Joncryl ADR | | | | | |
| | | 4370 + 1% Konz | | | | | |
| | | 2883. Cured | | | | | |
| Polyether | 85A | 94.5% 1185A10 + | Free | 0.68 | Extruded | 1.58 | 0.22 |
| | | 3% Konz 2894 + | Film | | | | |
| | | 1.5% Joncryl ADR | | | | | |
| | | 4370 + 1% Konz | | | | | |
| | | 2883. Cured | | | | | |

²Joncryl ADR 4370 is a melt strength enhancer commercially available from BASF Corporation of Florham Park, New Jersey.
³Konz 2894 is a physical blowing agent commercially available from BASF Corporation of Florham Park, New Jersey.
⁴Konz 2883 is color master batch additive commercially available from BASF Corporation of Florham Park, New Jersey.

As Table 1 illustrates, unfoamed free film test panels formed via an extrusion or injection molding process from thermoplastic polyurethane compositions having Shore hardness ratings within the range of the present invention did not achieve self sealability in accordance with Section 7.9 of ASTM 1970, as modified above.

Conversely, as illustrated in Table 2, foamed free film test panel formed via the extrusion or injection molding process and formed from the same or similar thermoplastic polyurethane compositions as in Table 1, and similar weights per square foot, achieved self sealability in accordance with Section 7.9 of ASTM 1970, as modified above.

Table 3 below lists additional unfoamed free film test panels having identical thermoplastic polyurethane compositions as some of the examples in Table 2, excluding the blowing agent. The unfoamed free film test panels in Table 3 were foamed via extrusion and had similar weights per square foot, or identical thicknesses, as some of the examples in Table 2. The unfoamed free film test panels in Table 3 also did not achieve self sealability in accordance with Section 7.9 of ASTM 1970, as modified above.

TABLE 3
Unfoamed TPU Samples Having Similar Weight Per Square Foot,
or Identical Thicknesses, as Foamed Samples in Table 2

| | Thickness | Density |
|---|---|---|
| Thermoplastic Polyurethane Composition | (mm) | (lb/ft²) |
| 98% Elastollan 1154D + 2% Konz 2883 | 1.30 | 0.309 |
| 96.5% Elastollan 1154D + 2% Konz 2883 + | 1.25 | 0.297 |
| 1.5% Joncryl ADR 4370 | | |
| 98% Elastollan 1154D + 2% Konz 2883 | 0.60 | 0.143 |
| 96.5% Elastollan 1154D + 2% Konz 2883 + | 0.83 | 0.197 |
| 1.5% Joncryl ADR 4370 | | |
| 98% Elastollan 1174D + 2% Konz 2883 | 1.56 | 0.371 |
| 96.5% Elastollan 1174D + 2% Konz 2883 + | 1.25 | 0.305 |
| 1.5% Joncryl ADR 4370 | | |
| 98% Elastollan 1174D + 2% Konz 2883 | 0.70 | 0.166 |
| 96.5% Elastollan 1174D + 2% Konz 2883 + | 0.63 | 0.154 |
| 1.5% Joncryl ADR 4370 | | |
| 98% Elastollan 1185A + 2% Konz 2883 | 0.625 | 0.143 |
| 96.5% Elastollan 1185A + 2% Konz 2883 + | 0.60 | 0.138 |
| 1.5% Joncryl ADR 4370 | | |

It is to be understood that the appended claims are not limited to express and particular compounds, compositions, or methods described in the detailed description, which may vary between particular embodiments which fall within the scope of the appended claims. With respect to any Markush groups relied upon herein for describing particular features or aspects of various embodiments, it is to be appreciated that different, special, and/or unexpected results may be obtained from each member of the respective Markush group independent from all other Markush members. Each member of a Markush group may be relied upon individually and/or in combination and provides adequate support for specific embodiments within the scope of the appended claims.

It is also to be understood that any ranges and subranges relied upon in describing various embodiments of the instant disclosure independently and collectively fall within the scope of the appended claims, and are understood to describe and contemplate all ranges including whole and/or fractional values therein, even if such values are not expressly written herein. One of skill in the art readily recognizes that the enumerated ranges and subranges sufficiently describe and enable various embodiments of the instant disclosure, and such ranges and subranges may be further delineated into relevant halves, thirds, quarters, fifths, and so on. As just one example, a range “of from 0.1 to 0.9” may be further delineated into a lower third, i.e., from 0.1 to 0.3, a middle third, i.e., from 0.4 to 0.6, and an upper third, i.e., from 0.7 to 0.9, or any range between the endpoints, which individually and collectively are within the scope of the appended claims, and may be relied upon individually and/or collectively and provide adequate support for specific embodiments within the scope of the appended claims. In addition, with respect to the language which defines or modifies a range, such as “at least,” “greater than,” “less than,” “no more than,” and the like, it is to be understood that such language includes subranges and/or an upper or lower limit. As another example, a range of “at least 10” inherently includes a subrange of from at least 10 to 35, a subrange of from at least 10 to 25, a subrange of from 25 to 35, and so on, and each subrange may be relied upon individually and/or collectively and provides adequate support for specific embodiments within the scope of the appended claims. Finally, an individual number within a disclosed range may be relied upon and provides adequate support for specific embodiments within the scope of the appended claims. For example, a range “of from 1 to 9” includes various individual integers, such as 3, as well as individual numbers including a decimal point (or fraction), such as 4.1, which may be relied upon and provide adequate support for specific embodiments within the scope of the appended claims.

The instant disclosure has been described in an illustrative manner, and it is to be understood that the terminology which has been used is intended to be in the nature of words of description rather than of limitation. Obviously, many modifications and variations of the instant disclosure are possible in light of the above teachings. It is, therefore, to be understood that within the scope of the appended claims, the instant disclosure may be practiced otherwise than as specifically described.

1. A thermoplastic polyurethane foamed article comprising:
a thermoplastic polyurethane composition having a durometer hardness ranging from a Shore A hardness of 30 to a Shore D hardness of 75 foamed in the presence of a blowing agent,
wherein the thermoplastic polyurethane foamed article has a density ranging from 0.3 to 0.8 g/cm³ measured at 25° C. and is self sealable in accordance with Section 7.9 of ASTM D1970/D1970M-11.

2. The thermoplastic polyurethane foamed article according to claim 1, wherein the thermoplastic polyurethane composition has a durometer hardness ranging from a Shore A hardness of 50 to a Shore D hardness of 60.

3. The thermoplastic polyurethane foamed article according to claim 1, further comprising a melt strength enhancer present in an amount from 0.1 to 5% of the total combined weight of the thermoplastic polyurethane composition and melt strength enhancer.

4. The thermoplastic polyurethane foamed article according to claim 3, wherein the melt strength enhancer comprises an epoxy-functional styrene acrylic copolymer.

5. The thermoplastic polyurethane foamed article according to claim 1, wherein the thermoplastic polyurethane composition comprises the reaction product of an isocyanate, a polyol and a chain extender.

6. The thermoplastic polyurethane foamed article according to claim 1, wherein the thermoplastic polyurethane composition comprises the reaction product of an isocyanate, a chain extender, and a polyol selected from a polyether polyol, a polyester polyol, a caprolactone, and combinations thereof

7. The thermoplastic polyurethane foamed article according to claim 5, wherein the chain extender comprises a diol.

8. An underlayment for roofing or flooring, the underlayment comprising the thermoplastic polyurethane foamed article according to claim 1, and having a thickness ranging from 0.6 mm to 2.0 mm and a weight per square foot ranging from 0.037 to 0.328 pounds per square foot.

9. A method for forming a foamed thermoplastic polyurethane article that is self sealable in accordance with Section 7.9 of ASTM D1970/D1970M-11, the method comprising:
providing a thermoplastic polyurethane composition having a durometer hardness ranging from a Shore A hardness of 30 to a Shore D hardness of 75 and a blowing agent;
melting the thermoplastic polyurethane composition in the presence of the blowing agent; and
foaming the melted thermoplastic polyurethane composition in the presence of the blowing agent to form the foamed thermoplastic polyurethane article having a density ranging from 0.3 to 0.8 g/cm³ measured at 25° C.

10. The method according to claim 9, wherein foaming the melted thermoplastic polyurethane composition comprises depressurizing the melted thermoplastic polyurethane composition.

11. The method according to claim 9, wherein melting the thermoplastic polyurethane composition in the presence of the blowing agent comprises:
introducing the provided thermoplastic polyurethane composition and blowing agent into an extruder; and
heating the thermoplastic polyurethane composition to a temperature sufficient to melt the thermoplastic polyurethane composition.

12. The method according to claim 9, wherein foaming the melted thermoplastic polyurethane composition in the presence of the blowing agent comprises injecting the melted thermoplastic polyurethane composition into a mold cavity from the extruder.

13. The method according to claim 9, wherein foaming the melted thermoplastic polyurethane composition in the presence of the blowing agent comprises releasing the melted thermoplastic material through a die opening in the extruder and onto a conveyor in a continuous process.

14. The method according to claim 9, further comprising introducing a melt strength enhancer to the provided thermoplastic polyurethane composition present in an amount from 0.1 to 5% of the total combined weight of the thermoplastic polyurethane composition and the melt strength enhancer.

15. The method according to claim 9, further comprising curing the foamed thermoplastic polyurethane article.

16. The thermoplastic polyurethane foamed article according to claim 2, further comprising a melt strength enhancer present in an amount from 0.1 to 5% of the total combined weight of the thermoplastic polyurethane composition and melt strength enhancer, wherein the melt strength enhancer comprises an epoxy-functional styrene acrylic copolymer.
